(19) United States
(12) Patent Application Publication
(10) Pub. No.: US 2017/0271654 A1
(43) Pub. Date: Sep. 21, 2017

(54) POLYMER COATED SILICON AS ELECTRODE MATERIAL FOR LITHIUM-ION BATTERY

(71) Applicant: NISSAN NORTH AMERICA, INC., Franklin, TN (US)

(72) Inventors: Ying Liu, Walled Lake, MI (US); Kenzo Oshihara, Novi, MI (US)

(21) Appl. No.: 15/071,888

(22) Filed: Mar. 16, 2016

(51) Int. Cl. H01M 4/36; H01M 4/62; H01M 4/38; H01M 10/0525

(52) U.S. Cl. CPC H01M 4/366; H01M 10/0525; H01M 4/628; H01M 4/386; H01M 4/387; H01M 4/38; H01M 2220/20

(57) ABSTRACT

A lithium ion battery has an anode comprising a current collector, a separator and an active material layer having active material particles. Each active material particle comprises a core of an alloying material including silicon and a polymer coating on the core, the polymer coating comprising a heat-shrinking polymer that shrinks as temperature increases. As cycling increases across a life of the lithium ion battery, an expansion amount of the alloying material of the core increases, temperature of the anode increases, and an amount of shrinkage of the polymer coating increases, such that as the core attempts to expand against the polymer coating, the polymer coating exerts an opposite force on the core.

### TECHNICAL FIELD

This disclosure relates to an electrode for a lithium ion battery having catalyst comprising polymer coated silicon as the active material, with the polymer in particular being a heat shrinking polymer.

### BACKGROUND

Hybrid vehicles (HEV) and electric vehicles (EV) use chargeable-dischargeable energy storages. Secondary batteries such as lithium-ion batteries are typical energy storages for HEV and EV vehicles. Lithium-ion secondary batteries typically use carbon, such as graphite, as the anode electrode. Graphite materials are very stable and exhibit good cycle-life and durability. However, graphite material suffers from a low theoretical lithium storage capacity of only about 372 mAh/g. This low storage capacity results in poor energy density of the lithium-ion battery and low electric mileage per charge.

To increase the theoretical lithium storage capacity, silicon has been added to active materials. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon causes particle cracking and pulverization. This deteriorative phenomenon escalates to the electrode level, leading to electrode delamination, loss of porosity, electrical isolation of the active material, increase in electrode thickness, rapid capacity fade and ultimate cell failure.

### SUMMARY

Disclosed herein are an active material for a lithium ion battery and an electrode using the active material. The active material for an electrode of a lithium ion battery comprises a core of an alloying material and a polymer coating on the core, the polymer coating comprising a heat-shrinking polymer that shrinks as temperature increases. As the temperature increases, a shrinkage of the polymer coating offsets an expansion of the alloying material.

Also disclosed is a lithium ion battery having an anode comprising a current collector, a separator and an active material layer having active material particles each comprising a core of an alloying material including silicon and a polymer coating on the core, the polymer coating comprising a heat-shrinking polymer that shrinks as temperature increases. As cycling increases across a life of the lithium ion battery, an expansion amount of the alloying material of the core increases, temperature of the anode increases, and an amount of shrinkage of the polymer coating increases, such that as the core attempts to expand against the polymer coating, the polymer coating exerts an opposite force on the core.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a lithium ion battery.

FIG. 2A is a cross sectional view of an active material layer as disclosed herein.

FIG. 2B is a cross section view of the active material layer of FIG. 2A during lithiation and a temperature increase.

FIG. 3 is an enlarged view of an active material particle illustrating the porosity of the polymer coating.

### DETAILED DESCRIPTION

Because the carbon material used in electrodes of conventional batteries, such as lithium ion batteries or sodium ion batteries, suffers from a low specific capacity, the conventional battery has poor energy density even though there is small polarization and good stability. Furthermore, batteries having electrodes of graphite or other carbon materials develop increased internal resistance over time, which decreases their ability to deliver current.

To address the poor energy density of carbon based electrodes, alternative active materials with higher energy densities are desired. Alloying particles such as silicon, tin, germanium and their oxides and alloys are non-limiting examples of materials that may be added to an electrode active material layer to improve its energy density, among other benefits.

One particular example is the use of silicon in lithium-ion batteries. Electrode materials such as silicon react with lithium via a different mechanism than graphite. Lithium forms alloys with silicon materials, which involves breaking the bonds between host atoms, causing dramatic structural changes in the process. Since the silicon does not constrain the reaction, anode materials that form alloys can have much higher specific capacity than intercalation electrode materials such as graphite. Silicon based anode active materials have potential as a replacement for the carbon material of conventional lithium-ion battery anodes due to silicon's high theoretical lithium storage capacity of 3500 to 4400 mAh/g. Such a high theoretical storage capacity could significantly enhance the energy density of the lithium-ion batteries. However, silicon active materials suffer from rapid capacity fade, poor cycle life and poor durability. One primary cause of this rapid capacity fade is the massive volume expansion of silicon (typically up to 300%) and structural changes due to lithium insertion. Volume expansion of silicon can cause particle cracking and pulverization when the silicon has no room to expand, which leads to delamination of the active material from the current collector, electrical isolation of the fractured or pulverized active material, capacity fade due to collapsed conductive pathways, and increased internal resistance over time.

Disclosed herein is active material comprising core shell particles having alloying material as the core and a polymer coating on the core, the polymer coating comprising a heat-shrinking polymer that shrinks as temperature increases. The alloying material includes active catalyst particles that have a high lithium storage capacity resulting in large volume expansions during lithiation. The polymer coating is activated during charging and discharging of the battery by increasing and decreasing temperatures. When activated, the polymer coating maintains the structure and stability of the alloying material by expanding and contracting with the volume expansion and contraction of the alloying particles during lithiation and delithiation, respectively. As the battery ages, its temperature increases with increasing cycles. Alloying material tends to crack and pulverize over time as cycled, and the polymer coating reduces cracking and pulverization of the alloying particles, and contains any material resulting from cracking and pulverization, thereby maintaining battery energy density through the life of the battery.

The ability of the polymer coating to expand and contract with temperature eliminates many of the issues resulting from the use of traditional core shell materials. For example, silicon or silicon oxide coated with carbon does provide high capacity material. However, the carbon coating cracks and loosens over time as the silicon core expands and contracts.

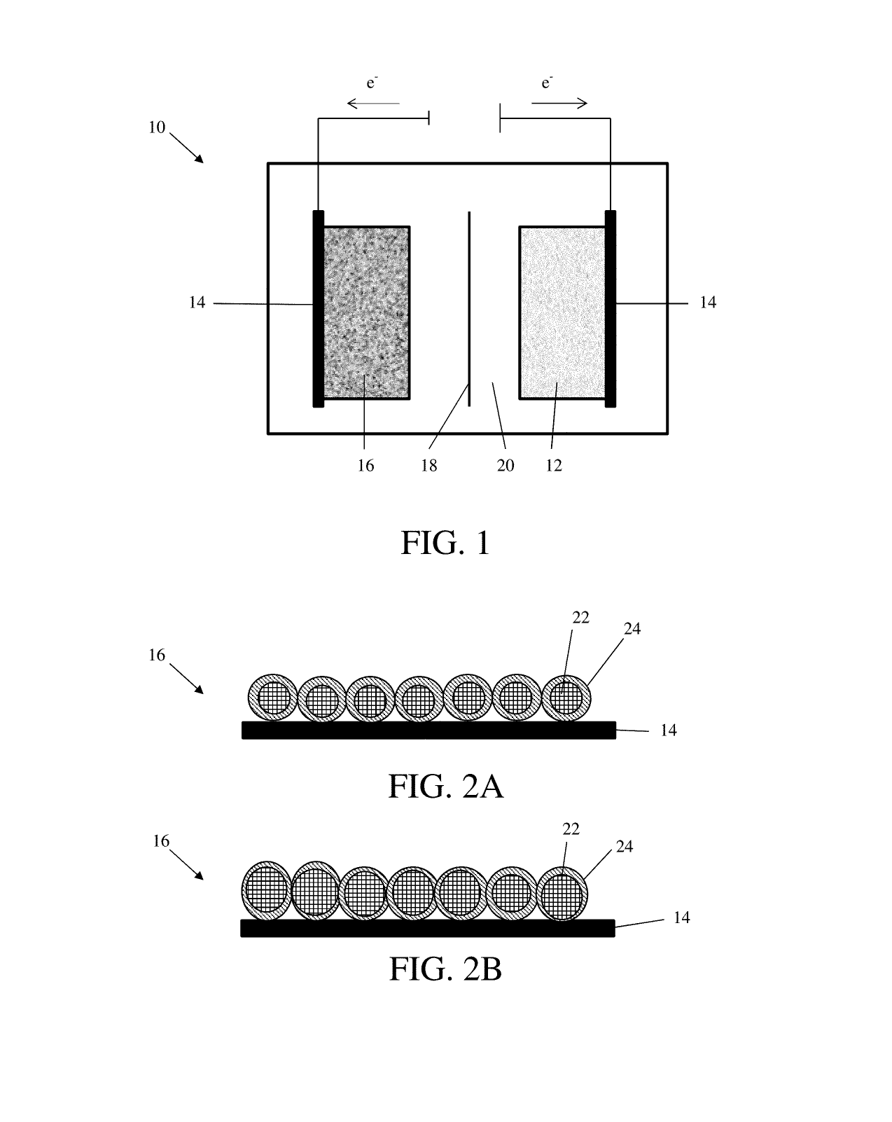

A lithium ion battery 10 is schematically illustrated in FIG. 1. The power generating element of the lithium ion battery 10 includes a plurality of unit cells, of which only one is depicted in FIG. 1. Each unit cell includes a cathode active material layer 12 on a current collector 14, an anode active material layer 16 on a current collector 14, a separator 18 and electrolyte 20.

Examples of the cathode active material layer may 12 include lithium-transition metal composite oxides such as LiMn₂O₄, LiCoO₂, LiNiO₂, Li(Ni—Co—Mn)O₂, lithium-transition metal phosphate compounds, and lithium-transition metal sulfate compounds. These are provided by means of example and are not meant to be limiting. As the electrolyte 20, a liquid electrolyte, a gel electrolyte or a polymer electrolyte known to those skilled in the art may be used. As examples, the liquid electrolyte may be in the form of a solution in which a lithium salt is dissolved in an organic solvent. The gel electrolyte may be in the form of a gel in which the above mentioned liquid electrolyte is impregnated into a matrix polymer composed of an ion conductive polymer. Examples of the separator 18 are porous films of polyolefin such as polyethylene and polypropylene. The current collector 14 is composed of a conductive material serving as a joining member for electrically connecting the active material layers to the outside, such as copper.

As illustrated in FIG. 2A, the anode active material layer 16 comprises a core 22 of an alloying material and a polymer coating 24 on the core 22. The polymer coating 24 comprises a heat-shrinking polymer that shrinks as temperature increases.

The alloying material of the core 22 can be silicon-based or tin-based, for example. The silicon-based particles can be silicon, a silicon alloy, a silicon/germanium composite, silicon oxide and combinations thereof. The tin-based particles can be tin, tin oxide, a tin alloy and combinations thereof. Other high energy density materials known to those skilled in the art are also contemplated. As discussed above, this high capacity for lithium ions results in large volume expansion of the alloying material and thus the core 22. To adequately form the polymer coating 24 on the core 22, the core 22 is at least one micron in diameter.

The polymer coating 24 is a heat-shrinking polymer, such as polytetrafluoroethylene, that shrinks with increasing temperature and returns to its original size at ambient temperature. As the temperature increases, shrinkage of the polymer coating 24 offsets an expansion of the alloying material. The heat-shrinking polymer can be formed from a functionalized polymer, a material that exhibits stimuli-responsive functions, thus achieving a desired output upon being subjected to a specific input, such as temperature. Polymeric materials exhibit a range of mechanical responses which depend on the chemical and physical structure of the polymer chains. At the microscopic level, the mobility of polymer chains in the presence of an external stimulus is dependent on the degree of cross-linking and entanglements present in the polymer, as well as the functional groups used along the polymer chain. The polymer used to form the polymer coating 24 will be selected based on the operating temperature range of a lithium ion battery as well as the change in chain length desired, as non-limiting examples.

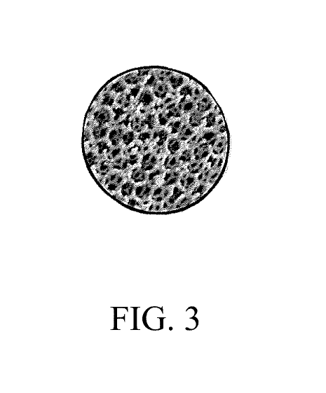

The polymer coating is non-conductive. Therefore, to allow lithium ions to pass to the active core 22, the polymer coating 24 is porous, as illustrated in FIG. 3, with pores sized to pass the lithium ions. The polymer coating 24 is also a thin coating to allow for passage of the lithium ions through the pores to the core 22.

During cycling of the lithium ion battery 10, the temperature fluctuates. As the temperature increases during a cycle and the core 22 is lithiated, the core 22 expands. Because the temperature has increased, the polymer coating 24 will shrink based on the increase in temperature, exerting an opposite force on the expanding core 22. As illustrated in FIG. 2B, this force exerted by the polymer coating 24 can reduce expansion of the core 22, maintain the structure of the core 22 during expansion, and reduce cracking and pulverization that occurs as the core 22 expands against adjacent particles.

As the battery life increases, the number of cycles performed increases and the overall temperature of the lithium ion battery 10 increases. As cycling increases across the life of the lithium ion battery 10, the active material typically experiences degradation due to repeated expansion/contraction, contact with adjacent particles during expansion, and dissolution of active particles. The core 22 also increases in size in the delithiated state as the number of cycles increases. This is due to lithium ions being retained in the core 22 as well as the formation of a solid-electrolyte interphase formed on the surface of the active material. In addition to the benefits of the polymer coating 24 disclosed herein during a single cycle, the polymer coating 24 minimizes pulverization and cracking due to expansion, reduces dissolution, maintains the structure of the core 22 across the life of the lithium ion battery 10 and contains the expansion of the delithiated core 22 as the number of cycles increases.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A or B, X can include A alone, X can include B alone or X can include both A and B. In addition, the articles “a” and “an” as used in this application and the appended claims should generally be construed to mean “one or more” unless specified otherwise or clear from context to be directed to a singular form.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

Other embodiments or implementations may be within the scope of the following claims.

What is claimed is:

1. An active material for an electrode of a lithium ion battery, the active material comprising:
a core of an alloying material; and
a polymer coating on the core, the polymer coating comprising a heat-shrinking polymer that shrinks as temperature increases, wherein, as the temperature increases, a shrinkage of the polymer coating offsets an expansion of the alloying material.

2. The active material of claim 1, wherein the polymer coating is porous, with pores sized to pass lithium ions.

3. The active material of claim 1, wherein the core is at least one micron in diameter.

4. The active material of claim 1, wherein the alloying material is silicon.

5. The active material of claim 1, wherein the alloying material is tin or germanium.

6. The active material of claim 1, wherein the heat-shrinking polymer is polytetrafluoroethylene.

7. An electrode comprising the active material of claim 1, the electrode comprising:
a current collector;
a separator; and
an active material layer on the current collector comprising the active material.

8. The electrode of claim 5, wherein the active material layer is spaced from the separator.

9. The electrode of claim 5, wherein, as cycling increases across a life of the electrode, temperature of the electrode increases, and an amount of shrinkage of the polymer coating increases, such that as the core attempts to expand against the polymer coating, the polymer coating exerts an opposite force on the core.

10. A lithium ion battery having an anode comprising:
a current collector;
a separator; and
an active material layer having active material particles each comprising:
a core of an alloying material including silicon; and
a polymer coating on the core, the polymer coating comprising a heat-shrinking polymer that shrinks as temperature increases,
wherein, as cycling increases across a life of the lithium ion battery, an expansion amount of the alloying material of the core increases, temperature of the anode increases, and an amount of shrinkage of the polymer coating increases, such that as the core attempts to expand against the polymer coating, the polymer coating exerts an opposite force on the core.

11. The lithium ion battery of claim 10, wherein the polymer coating is porous, with pores sized to pass lithium ions.

12. The lithium ion battery of claim 10, wherein the core is at least one micron in diameter.

13. The lithium ion battery of claim 10, wherein the heat-shrinking polymer is polytetrafluorethylene.
